(19) United States
(12) Patent Application Publication
(10) Pub. No.: US 2018/0003885 A1
(43) Pub. Date: Jan. 4, 2018

(54) GLASS AND GLASS MEMBER

(71) Applicant: Asahi Glass Company, Limited, Chiyoda-ku (JP)

(72) Inventors: Katsumi SUZUKI, Chiyoda-ku (JP); Yuki KONDO, Chiyoda-ku (JP)

(73) Assignee: Asahi Glass Company, Limited, Chiyoda-ku (JP)

(21) Appl. No.: 15/707,229

(22) Filed: Sep. 18, 2017

Related U.S. Application Data
(63) Continuation of application No. PCT/JP2016/062910, filed on Apr. 25, 2016.

(30) Foreign Application Priority Data
May 12, 2015 (JP) 2015-097712

(51) Int. Cl. F21V 8/00; C03C 3/087; C03C 3/091; G02F 1/1335

(52) U.S. Cl. CPC G02B 6/0051; G02F 1/133606; C03C 3/087; C03C 3/091

(57) ABSTRACT

A glass includes a first surface; and a second surface that is opposite to the first surface, wherein an absorption coefficient of the glass at light of wavelength 550 nm is less than or equal to 1 m⁻¹, and a ratio (αₘₐₓ /αₘᵢₙ) of a maximum value αₘₐₓ (m⁻¹) to a minimum value αₘᵢₙ (m⁻¹) of absorption coefficients of the glass at light within a range of wavelengths from 400 nm to 700 nm is less than or equal to 10, and wherein a two-dimensional arithmetical mean height of a selectable area of 1790 μm×1330 μm of the first surface is less than or equal to 1 nm.

### CROSS-REFERENCE TO RELATED APPLICATION

This application is a continuation application filed under 35 U.S.C. 111(a) claiming the benefit under 35 U.S.C. 120 and 365(c) of PCT International Application No. PCT/JP2016/062910 filed on Apr. 25, 2016, which is based upon and claims the benefit of priority of Japanese Priority Application No. 2015-097712 filed on May 12, 2015 and the entire contents of which are hereby incorporated by reference.

### BACKGROUND OF THE INVENTION

### 1. Field of the Invention

The present invention relates to a glass and a glass member.

### 2 . Description of the Related Art

In recent years, liquid crystal displays are provided in personal digital assistants or the like such as liquid crystal televisions, tablet terminals or smartphones. The liquid crystal display includes a planar light-emitting device as a backlight, and a liquid crystal panel placed at a light outputting surface side of the planar light-emitting device.

There are two types of planar light-emitting devices, a direct type and an edge light type. The edge light type is widely used because it can reduce a size of a light source. An edge light type planar light-emitting device includes a light source, a light guide plate, a reflecting sheet, a diffusion sheet and the like.

Light from the light source is input in the light guide plate from a light inputting end surface (simply referred to as a “light inputting surface” as well) formed at a side surface of the light guide plate. The light guide plate includes a light outputting surface which faces the liquid crystal panel, and a light reflecting surface that is opposite to the light outputting surface. A plurality of reflecting dots are formed at the light reflecting surface of the light guide plate. The reflecting sheet is placed to face the light reflecting surface, and the diffusion sheet is placed to face the light outputting surface.

The light input from the light source to the light guide plate proceeds in the light guide plate while being reflected by the reflecting dots and the reflecting sheet, and is output from the light outputting surface. The light output from the light outputting surface is input in the liquid crystal panel after being diffused by the diffusion sheet.

As a material of the light guide plate, a glass whose transmittance is high and heat-resistance is good may be used (see Patent Documents 1 and 2).

When a glass is used as the light guide plate, as described above, the diffusion sheet is placed to face the light outputting surface of the glass. Here, there is a problem of the diffusion sheet not being appropriately placed at the light outputting surface, and brightness of output light varying by locations (hereinafter, referred to as “brightness unevenness”).

However, it has not been sufficiently considered how to set a surface condition of the light outputting surface in order to appropriately provide the diffusion sheet at the light outputting surface to prevent such a problem of the brightness unevenness at the light outputting surface.

Further, even for a case in which a glass is used for a purpose other than the light guide plate, there is a problem when a functional sheet object made of a resin material (a shatterproof sheet or a surface protection sheet, for example) is placed at a main surface of the glass, such that a function of the functional sheet object cannot be sufficiently obtained because the functional sheet object cannot be appropriately placed at the main surface of the glass.

### Patent Documents

### [Patent Document 1] Japanese Laid-open Patent Publication No. 2013-093195

### [Patent Document 2] Japanese Laid-open Patent Publication No. 2013-030279

### SUMMARY OF THE INVENTION

The present invention is made in light of the above problems, and provides a glass and a glass member for which it is possible to appropriately place a sheet object such as a diffusion sheet at a main surface.

According to an embodiment, there is provided a glass including a first surface; and a second surface that is opposite to the first surface, wherein an absorption coefficient of the glass at light of wavelength 550 nm is less than or equal to 1 m⁻¹, and a ratio (αₘₐₓ / αₘᵢₙ) of a maximum value αₘₐₓ (m⁻¹) to a minimum value αₘᵢₙ (m⁻¹) of absorption coefficients of the glass at light within a range of wavelengths from 400 nm to 700 nm is less than or equal to 10, and wherein a two-dimensional arithmetical mean height of a selectable area of 1790 μm×1330 μm of the first surface is less than or equal to 1 nm.

### BRIEF DESCRIPTION OF THE DRAWINGS

Other objects, features and advantages of the present invention will become more apparent from the following detailed description when read in conjunction with the accompanying drawings.

FIG. 1 is a view schematically illustrating a liquid crystal display in which a glass of an embodiment is used as a light guide plate;

FIG. 2 is a view illustrating a result obtained by conducting an experiment to measure a surface roughness of a narrow area of a sample in each example and each comparative example;

FIG. 3 is a view illustrating a result obtained by conducting an experiment to measure a surface roughness of a wide area of a sample in each example and each comparative example; and

FIG. 4 is a view illustrating a result obtained by conducting an experiment to measure a surface electrical resistance and coefficients of friction between a diffusion sheet and a sample of each example and each comparative example.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated. Further, the drawings are not intended, unless otherwise indicated, to indicate a relative ratio between members or components. Thus, specific sizes of the members or the components may be determined by those skilled in the art based on the following non-limiting embodiments.

Further, the following embodiments are just examples and are not limiting the invention. Thus, all the features or their combinations described in the embodiments are not necessarily essential for the invention.

### (Description of Structure of Planar Light-emitting Device)

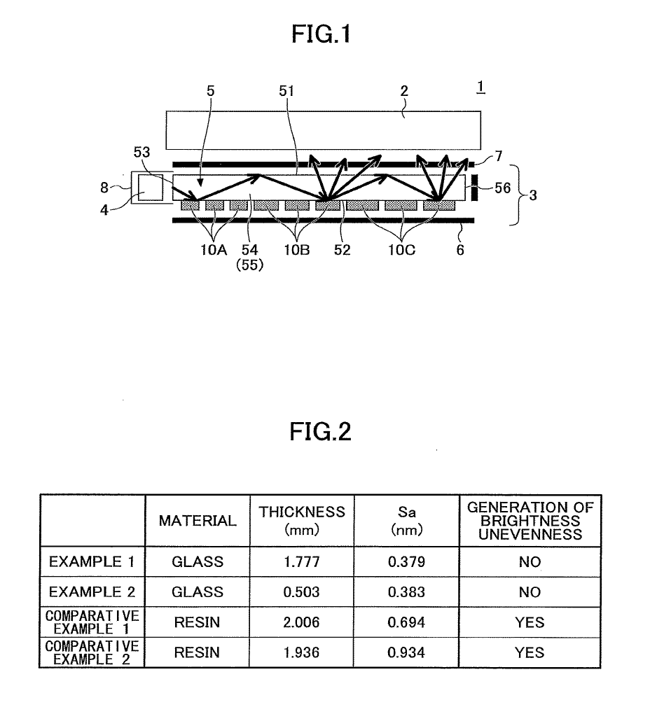

FIG. 1 illustrates a liquid crystal display 1 in which a glass of an embodiment id used as a light guide. The liquid crystal display 1 is mounted on, for example, a miniaturized and thinned electronic device such as a personal digital assistant.

The liquid crystal display 1 includes a liquid crystal panel 2 and a planar light-emitting device 3.

In the liquid crystal panel 2, an orientation layer, a transparent electrode, a glass substrate and a polarizing filter are stacked to sandwich a liquid crystal layer that is provided at a center. Further, a color filter is provided at one surface of the liquid crystal layer. By applying a driving voltage to the transparent electrode, molecules of the liquid crystal layer rotate around orientation axes, respectively, and with this, a predetermined image is displayed.

The planar light-emitting device 3 adopts an edge light type to be miniaturized and thinned. The planar light-emitting device 3 Includes a light source 4, a light guide plate 5, a reflecting sheet 6, a diffusion sheet 7 and reflecting dots 10A to I0C,

Light injected from the light source 4 into the light guide plate 5 proceeds in the light guide plate 5 while being reflected by the reflecting dots 10A to IOC and the reflecting sheet 6, and is output from a light outputting surface 51 of the light guide plate 5 that faces the liquid crystal panel 2. The light output from the light outputting surface 51 is incident to the liquid crystal panel 2 after being diffused by the diffusion sheet 7.

Although the light source 4 is not specifically limited, a hot-cathode tube, a cold-cathode tube or an LED (Light Emitting Diode) may be used. The light source 4 is placed to face a light inputting surface 53 of the light guide plate 5.

Further, a reflector 8 is provided at a back surface side of the light source 4 to improve incidence efficiency of the light that is radially emitted from the light source 4 into the light guide plate 5.

The reflecting sheet 6 has a structure in which a member that reflects light covers a surface of a resin sheet made of acrylic resin or the like. The reflecting sheet 6 is provided at a light reflecting surface 52, and at non-light inputting surfaces 54, 55 and 56 (55 is a surface that is opposite to 54) of the light guide plate 5.

The light reflecting surface 52 is a surface that is opposite to the light outputting surface 51 of the light guide plate 5. The non-light inputting surfaces 54 to 56 are end surfaces of the light guide plate 5 aside from the light reflecting surface 52 and the light inputting surface 53. Here, if it is unnecessary to particularly improve the incidence efficiency, the reflecting sheet 6 need not be provided at each of the non-light inputting surfaces 54 to 56.

As the diffusion sheet 7, a milk-white film made of acrylic resin or the like may be used. As the diffusion sheet 7 diffuses light output from the light outputting surface 51 of the light guide plate 5, light without brightness unevenness, in other words, uniform light can be irradiated at a back surface side of the light liquid crystal panel 2.

The diffusion sheet 7 is placed at the light outputting surface 51 of the light guide plate 5. If the diffusion sheet 7 Is not appropriately placed at the light outputting surface 51, brightness unevenness occurs, as described above.

In this embodiment, a glass member is constituted by a glass that constitutes the light guide plate 5, and by a functional resin sheet that Includes a resin material as a main component. The functional resin sheet may be selected from the reflecting sheet 6 and the diffusion sheet 7. In this embodiment, such a glass member is used as the planar light-emitting device 3. Further, the reflecting dots 10A to IOC and the like may be provided at the glass member as well.

In the following, at is assumed that the functional resin sheet is the diffusion sheet 7. In the glass member of the embodiment, it is preferable that a coefficient of static friction between the light outputting surface 51 of the light guide plate 5 and the diffusion sheet 7 is less than or equal to 0.20. When the coefficient of static friction is less than or equal to 0.20, it is easy to relocate the diffusion sheet 7 at the light outputting surface 51 for appropriate placement of the diffusion sheet 7 after a previous placement thereof.

It is preferable that a coefficient of kinetic friction between the light outputting surface 51 of the light guide plate 5 and the functional resin sheet such as the diffusion sheet 7 is less than or equal to 0.20 in the glass member of the embodiment, When the coefficient of kinetic friction is less than or equal to 0.20, it is easy to appropriately place the functional resin sheet such as the diffusion sheet 7 at the light outputting surface 51 without generation of wrinkles.

Next, a structure of the glass that constitutes the light guide plate 5 is described.

### (Surface Roughness)

The glass of the embodiment includes a first surface and a second surface that is opposite to the first surface. When the glass of the embodiment is used as the light guide plate 5, for example, the first surface may function as the light outputting surface 51, and the second surface may function as the light reflecting surface 52.

A two-dimensional arithmetical mean height (Sa) of the first surface of the glass of the embodiment, at a selectable area of 1790μm×1330 μm (hereinafter, referred to as a “wide area”) of the first surface is less than or equal to 1 nm. Here, the two-dimensional arithmetical mean height (Sa) is based on ISO 25178. When the “Sa” at a selectable wide area of the first surface is less than or equal to 1 nm, generation of asperities (or waviness) of a relatively large period at the first surface can be reduced. With this, for example, when placing the functional resin sheet such as the diffusion sheet 7 at the first surface, a coefficient of static friction between the first surface and the functional resin sheet can be made small, preferably, less than or equal to 0.20.

Further, a two-dimensional arithmetical mean height (Sa) of the first surface of the glass of the embodiment, at a selectable area of 94 82 m×70 μm (hereinafter, referred to as a “narrow area”) of the first surface may be less than or equal to 0.4 nm. Here, the two-dimensional arithmetical mean height (Sa) is based on ISO 25178. When the “Sa” at a selectable narrow area of the first surface is less than or equal to 0.4 nm, generation of fine uneven portions at the first surface can be reduced. With this, for example, when placing the functional resin sheet such as the diffusion sheet 7 at the first surface, a coefficient of kinetic friction between the first surface and the functional resin sheet can be made small, preferably, less than or equal to 0.20.

The two-dimensional arithmetical mean height (Sa) of each of the wide area and the narrow area of the first surface of the glass of the embodiment may be adjusted by materials added to a glass material. Alkaline-earth metal oxides such as MgO, CaO, SrO and BaO are effective components to promote melting of the glass material, adjust thermal expansion, viscosity and the like and reduce the two-dimensional arithmetical mean height of the formed glass.

In order to set the two-dimensional arithmetical mean height at the narrow area to be less than or equal to 0.4 nm, and the two-dimensional arithmetical mean height at the wide area to be less than or equal to 1.0 nm, it is preferable that a total content of alkaline-earth metal oxides (MgO+CaO+SrO+BaO) is greater than or equal to 10 mass %, and more preferably greater than or equal to 13 mass % in a glass composition A (which will be described later); greater than or equal to 1mass %, and more preferably, greater than or equal to 10 mass % in a glass composition B (which will be described later); and greater than or equal to 5 mass %, and more preferably, greater than or equal to 10 mass % in a glass composition C (which will be described later). However, if the total content becomes too high, amounts of other components become relatively small, which leads to problems of devitrification characteristics and intensity. Thus, it is preferable that the total content of the alkaline-earth metal oxides is less than or equal to 30 mass %, and more preferably, less than or equal to 27 mass % in the glass composition A; less than or equal to 15 mass %, and more preferably, less than or equal to 10 mass % in the glass composition B; and less than or equal to 30 mass %, and more preferably, less than or equal to 20 mass % in the glass composition C.

### (Absorption Coefficient of Light)

An absorption coefficient of the glass of the embodiment at light of wavelength 550 nm is less than or equal to 1 m⁻¹. The reason for using the absorption coefficient at the light of wavelength 550 nm as a decision index is because, generally, the absorption coefficient at the light of wavelength 550 nm becomes the maximum, among light within a range of wavelengths from 400 nm to 700 nm.

With this, absorption of three colors of light, R (red), G (green) and B (blue), used as light sources of a liquid crystal television in which an edge light type planar light-emitting device is used, becomes small.

It is preferable that a maximum value αₘₐₓ of absorption coefficients of the glass of the embodiment at light within a range of wavelengths from 400 nm to 700 nm is less than or equal to 1 m⁻¹.

Further, a ratio (αₘₐₓ / αₘᵢₙ) Of the maximum value αₘₐₓ (m⁻¹) to a minimum value αₘᵢₙ (m⁻¹) of the absorption coefficients fit the light within a range of wavelengths from 400 nm to 700 nm is less than or equal to 10,.

Here, the reason for using the absorption coefficients at the light within a range Of wavelengths from 400 nm to 700 nm as a decision index is because wavelengths of three colors of light, R (red), G (green) and B (blue) are included in this range.

With this, absorption of three colors of light, R (red), G (green) and B (blue), used as a light source of a liquid crystal television in which an edge light type planar light-emitting device is used, becomes small, and a difference between absorptions of light within a range of wavelengths from 400 to 780 nm becomes small as well.

### (Light Absorption)

A main factor in light absorption of a glass is iron ions included as impurities. iron is inevitably included in a material of an industrially manufactured glass, and contamination of iron into the glass cannot be avoided.

A content of total iron oxide (t-Fe₂O₃), calculated in terms of Fe₂O₃, in the glass of the embodiment may be less than or equal to 80 mass ppm in order to actualize extremely high transmittance over the entirety of a visible range. It is more preferable that the content of t-Fe₂O₃is less than or equal to 60 mass ppm, furthermore preferably, less than or equal to 50 mass ppm, particularly preferably, less than or equal to 40 mass ppm, and most preferably less than or equal to 35 mass ppm.

Meanwhile, the content of t-Fe₂O₃ In the glass of the embodiment may be greater than or equal to 1 mass ppm. If the content is less than 1 mass ppm. It, is difficult to improve a fusion property of a glass when manufacturing a multi-component oxide glass, and also it is difficult to mass produce the glass at low cost. Further, it is difficult to obtain a material. Preferably, the content is greater than or equal to 5 mass ppm, more preferably, greater than or equal to 8 mass ppm, and furthermore preferably, greater than or equal to 10 mass ppm. Here, the content of t-Fe₂O₃ in the glass can be adjusted by an amount of an iron component that is added when manufacturing the glass.

In this embodiment, although the content of total iron oxide in the glass is expressed by an amount of Fe₂O₃, not all of iron in the glass exists as Fe³⁺ (ferric). Normally, Fe³⁺ and Fe²⁺ (ferrous) (hereinafter, these are referred to as “iron components”) exist in the glass at the same time. The iron components have absorption in the visible light range, and as an absorption coefficient of Fe²⁺ (11 cm⁻¹ Mol⁻¹) is larger than an absorption coefficient of Fe³⁺ (0.96 cm⁻¹ Mol⁻¹) by one order of magnitude, Fe²⁺ further lowers internal transmittance in the visible light range. Thus, it is preferable that the content of Fe²⁺ is low in order to improve the internal transmittance in the visible light range.

According to the glass of the embodiment, the content of ferrous (Fe²⁺), as calculated in terms of Fe₂O₃ and expressed by mass ppm, may be suppressed to be less than ox equal to 10 mass ppm. Preferably, the content is less than or equal to 8.0 mass ppm, more preferably, less than or equal to 6.0 mass ppm, furthermore preferably, less than or equal to 4.0 mass ppm, and particularly preferably, less than or equal to 3.5 mass ppm.

### (Internal Transmittance)

In order to further reduce light absorbency and obtain high transparency in the glass of the embodiment, it is preferable that a minimum value of internal transmittances of the glass at light within a range of wavelengths from 400 to 780 nm, under a condition that an optical length is 200 mm, is greater than or equal to 80%, and a difference between a maximum value and the minimum value of the internal transmittances is less than or equal to 15%.

Here, the optical length means a distance from one end surface at which light is input to an opposite end surface. The internal transmittance of the glass whose optical length is 200 mm can be measured as follows.

First, a glass is cut such that the optical length becomes 200 mm, and is polished such that a surface roughness Ra of each of a surface to which single-wavelength light, which will be described later, is input, and an opposing surface from which the light is output becomes less than or equal to 0.03 μm.

Next, light of a single-wavelength from 400 to 780 nm is vertically input to the polished surface by 1 nm pitch using a UV, a visible and near-infrared spectrophotometer UH4150 (manufactured by Hitachi High-Tech Science Corporation), and intensity of output light of the respective single-wavelength is measured. Then, transmittance at each wavelength is calculated based on intensities of incident light and outgoing light obtained as such.

It is preferable, for the glass used as the light guide plate 5, that the minimum value of the internal transmittance is greater than or equal to 85%, and a difference between the maximum value and the minimum value of the internal transmittances is less than or equal to 13%, and more preferably, the minimum value of the internal transmittance is greater than or equal to 90%, and the difference between the maximum value and the minimum value of the internal transmittances is less than or equal to 8%.

### (Glass Composition)

Although a composition of the glass of the embodiment is not specifically limited, the following three types (glasses having a glass composition A, a glass composition B and a glass composition C) may be typically exemplified.

For example, a glass plate having the glass composition A may include, expressed by mass % in terms of an oxide, substantially, 60 to 80% of SiO₂, 0 to 7% of Al₂O₃, 0 to 10% of MgO, 0 to 20% of CaO, 0 to 15% of SrO, 0 to 15% of BaO, 3 to 20% of Na₂O and 0 to 10% of K₂O.

Alternatively, a glass plate having the glass composition B may include, expressed by mass % in terms of an oxide, substantially, 45 to 80% of SiO₂, greater than 7% and less than or equal to 30% of Al₂O₃, 0 to 15% of B₂O₃, 0 to 15% of MgO, 0 to 6% of CaO, 0 to 5% of SrO, 0 to 5% of BaO, 7 to 20% of Na₂O, 0 to 10% of K₂O and 0 to 10% of ZrO₂.

Alternatively, a glass plate having the glass composition C may include, expressed by mass % in terms of an oxide, substantially, 45 to 70% of SiO₂, 10 to 30% of Al₂O₃, 0 to 15% of B₂O₃, 5to 30% in total of at least one component selected from a group consisting of MgO, CaO, SrO and BaO, and greater than or equal to 0% and less than 3% in total of at least one component selected from a group consisting of Li₂O, Na₂O and K₂O.

Further, in order to obtain high transparency, a glass with low light absorbance and good internal transmittance is used for the light guide plate 5 of the embodiment.

### (Electrical Characteristics)

It is preferable that a surface electrical resistance of the first surface of the glass of the embodiment is less than or equal to 2.5×10¹⁴ Ω/□. When the surface electrical resistance is less than or equal to 2.5×10¹⁴ Ω/ □, electrostatic generated above the first surface can easily flow out of the first surface. With this, when placing the functional resin sheet such as the diffusion sheet 7, the functional resin sheet can be prevented from being inappropriately attracted on the first surface due to the electrostatic of the first surface.

In order to set the surface electrical resistance of the glass to be less than or equal to 2.5×10¹⁴ Ω/□, it is preferable that a total content of alkaline metal oxides (Li₂O+Na₂O +K₂O) is 5 to 20 mass %, and more preferably, 8 to 15 mass % in each of the glass compositions A and B; and 0 to 2 mass %, and more preferably, 0 to 1 mass % in the glass composition C.

### Examples

It is preferable to use the above described glass as the light guide plate 5 because the light absorbency and the internal transmittance are good. However, even for such a glass with good characteristics being used, if the diffusion sheet 7 is not appropriately placed at the light outputting surface 51 of the light guide plate 5, brightness of output light varies by locations to generate brightness unevenness.

A surface condition of the light outputting surface 51 largely influences appropriate placement of the diffusion sheet 7 at the light outputting surface 51 of the light guide plate 5. Thus, the present inventors conducted the following experiments by paying attention to a surface roughness and electrical characteristics of the light outputting surface 51.

Here, in each of the following experiments, among the above described various characteristics of the glass, a glass was used that satisfies at least conditions including: the absorption coefficient of the glass at light of wavelength 550 nm is less than or equal to 1 m⁻¹, and the ratio (αₘₐₓ / αₘᵢₙ) of the maximum value αₘₐₓ (m⁻¹) to the minimum value αₘᵢₙ (m⁻¹) of the absorption coefficients of the glass at light within a range of wavelengths from 400 nm to 700 nm is less than or equal to 10 .

### (Example of Surface Roughness)

First, experiments conducted by the present inventors regarding the surface roughness of the light outputting surface 51 of the light guide plate 5 are described.

In these experiments, a surface roughness of the light outputting surface 51 was evaluated by a two-dimensional arithmetical mean height (Sa). The two-dimensional arithmetical mean height (Sa) was measured based on ISO25178.

Further, evaluation of the surface roughness was performed for two areas including a selectable area of 94 μm×70 μm (narrow area) of the light outputting surface 51, and a larger selectable area of 1790 μm×1330 μm (wide area) of the light outputting surface 51. Generation of asperities (or waviness) at the light outputting surface 51 can be measured by the wide area. Further, generation of fine uneven portions on such asperities can be measured by the narrow area.

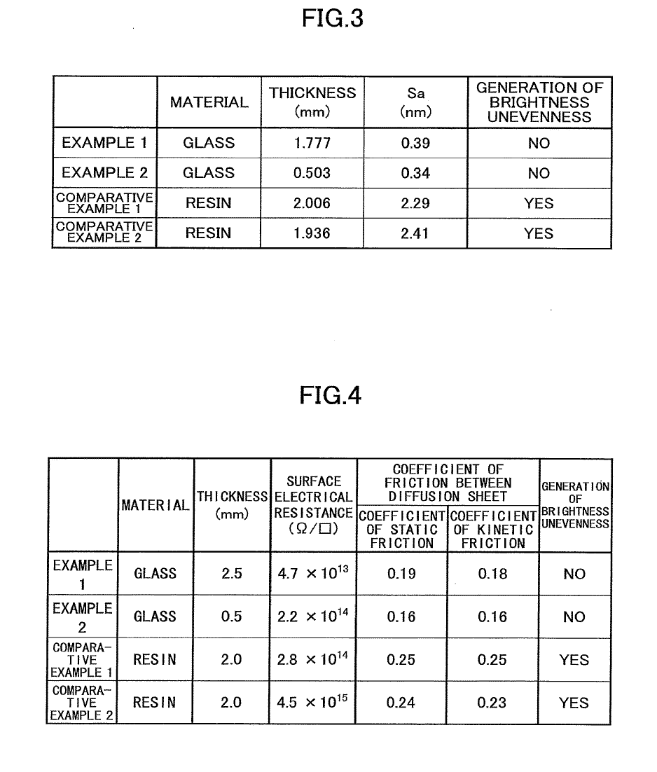

FIG. 2 illustrates an experimental result obtained by evaluating the surface roughness of the narrow area of the light outputting surface 51, and FIG. 3 illustrates an experimental result obtained by evaluating the surface roughness of the wide area of the light outputting surface 51.

In each of the experiments explained below, an experiment to evaluate the surface roughness was conducted on four samples including examples 1 and 2 and comparative examples 1 and 2.

Here, glasses were used as materials in examples 1 and 2. Further, resin materials were used in comparative examples 1 and 2.

A glass used in example 1 included, expressed by mass %, 69.8% of SiO₂, 3.2% of Al₂O₃, 11.1% of Na₂O, 0.1% of MgO, 7.9% of CaO, 3.9% of SrO, 4.0% of BaO and 0.003% of t-Fe₂O₃.

A glass used in example 2 included, expressed by mass %, 68.1% of SiO₂, 11.1% of Al₂O₃, 9.1% of B₂O₃, 2.4% of MgO, 8.7% of CaO, 0.6% of SrO and 0.005% of t-Fe₂O₃.

Further, SA light guide (manufactured by Sumika Acryl Co., Ltd.) was used in comparative example 1,and DENKA TX polymer (Manufactured by Denka Company Limited.) was used in comparative example 2.

Further, the liquid crystal display 1 was manufactured by using each of the samples, for each of which the surface roughness was evaluated, as the light guide plate 5, and providing the reflecting sheet 6 on the respective light guide plate 5. Then, an experiment to determine whether brightness unevenness was generated in each of the liquid crystal displays 1 was also conducted.

From the experimental result of the surface roughness of the narrow area illustrated in FIG. 2, the two-dimensional surface roughness (Sa) was greater than 4 nm in each of comparative examples 1 and 2 in which the resin was used. Further, in all of the liquid crystal displays 1 in which the samples of comparative examples 1 and 2 were used, brightness unevenness was generated.

On the other hand, in each of examples 1 and 2 in which the glass was used, the two-dimensional surface roughness (Sa) was less than or equal to 0.4 nm, which was smaller than that of each of comparative examples 1 and 2. Further, in all of the liquid crystal displays 1 in which the samples of examples 1 and 2 were used, brightness unevenness was not generated.

Thus, by the experimental result illustrated in FIG. 2, it was revealed that it is preferable that the two-dimensional arithmetical mean height of the selectable area of 94 μm×70μm (narrow area) of the main surface of the glass used as the light guide plate 5 (which becomes the light outputting surface SI) is less than or equal to 0.4 nm, in order to reduce generation of brightness unevenness.

Next, the experimental result of the surface roughness of the wide area illustrated in FIG. 3 is described.

According to the experimental result of the surface roughness of the wide area, the two-dimensional surface roughness (Sa) was greater than 1.0 nm in each of comparative examples 1 and 2 in which the resin was used. Further, in all of the liquid crystal displays 1 in which the samples of comparative examples 1 and 2 were used, brightness unevenness was generated.

On the other hand, in each of examples 1 and 2 in which the glass was used, the two-dimensional surface roughness (Sa) was less than or equal to 1.0 nm, which was smaller than that of each of comparative examples 1 and 2. Further, in all of the liquid crystal display 1 in which the samples of examples 1 and 2 were used, brightness unevenness was not generated.

Thus, by the experimental result illustrated in FIG. 3, it was revealed that it is preferable that the two-dimensional arithmetical mean height of the selectable area of 1790 μm×1330 μm (wide area) of the main surface of the glass used as the light guide plate 5 (which becomes the light outputting surface 51) is less than or equal to 1.0 nm, in order to reduce generation of brightness unevenness.

### (Example of Electrical Characteristics)

Next, experiments conducted by the present inventors regarding electrical characteristics of the light outputting surface 51 of the light guide plate 5 are described.

In these experiments, a surface electrical resistance of the light outputting surface 51 was measured. The measurement of the surface electrical resistance was conducted based on JIS K 6911.

Further, a coefficient of static friction and a coefficient of kinetic friction between the light outputting surface 51 of each of the samples, for each of which the measurement of the surface electrical resistance was conducted, and the diffusion sheet 7 were obtained. The coefficient of static friction and the coefficient of kinetic friction were obtained by conducting a test using a continuous loading scratching intensity tester TYPE18 (manufactured by Shinto Scientific Co., Ltd.) at 300 gf (≈2.94 N) loading at a speed of 1 mm/sec.

Further, the liquid crystal display 1 was manufactured by using each of the samples, for each of which the surface electrical resistance was measured, as the light guide plate 3, and providing the diffusion sheet 7 on it. Then, an experiment to determine whether brightness unevenness was generated In each of the liquid crystal displays 1 was also conducted.

FIG. 4 illustrates a result of measuring the surface electrical resistance of each of the light outputting surfaces 51, values of the coefficient of static friction and the coefficient of kinetic friction between each of the light outputting surfaces 51 and the diffusion sheet 7, and whether brightness unevenness was generated.

By the experimental result illustrated in FIG. 4, the surface electrical resistance was greater than or equal to 2.5×10¹⁴ 106 /□ in comparative examples 1 and 2 using resin. Further, in all of the liquid crystal displays 1 in which the samples of comparative examples 1 and 2 were used, brightness unevenness was generated.

When the surface electrical resistance is large such as greater than or equal to 2.5×10¹⁴ Ω/□, electrostatic is charged at the light outputting surface 51. Then, if the diffusion sheet 7 is placed at the light outputting surface 51 under this state, the diffusion sheet 7 is attracted onto the light outputting surface 51 by the electrostatic.

If such an attraction occurs, the coefficient of static friction between the light outputting surface 51 and the diffusion sheet 7 becomes large such as greater than or equal to 0.24, and it becomes difficult to appropriately place the diffusion sheet 7 at an upper surface of the light outputting surface 51. It is considered that the brightness unevenness is generated due to the attraction between the light outputting surface 51 and the diffusion sheet 7 by the electrostatic generated by increasing of the surface electrical resistance.

On the other hand, the surface electrical resistance becomes less than or equal to a value as small as 2.5×10¹⁴ Ω/□ in each of examples 1 and 2 using the glass, compared with comparative examples 1 and 2. Thus, as the electrical resistance is small, the electrostatic generated at the light outputting surface 51 can flow out of the light outputting surface 51. Thus, the diffusion sheet 7 can be prevented from being attracted onto the light outputting surface 51 due to the electrostatic. Thus, in examples 1 and 2, the coefficient of static friction between the light outputting surface 51 and the diffusion sheet 7 becomes small such as less than or equal to 0.20. Therefore, brightness unevenness was not generated in the liquid crystal display 1 used in examples 1 and 2.

Thus, by the experimental result illustrated in FIG. 4, it was revealed that it is preferable that the surface electrical resistance of a main surface (which becomes the light outputting surface 51) of a material such as a glass used as the light guide plate 5 is less than or equal to 2.5×10¹⁴ Ω/□, in order to reduce generation of brightness unevenness. Further, it was revealed that it is preferable that the coefficient of static friction between a main surface of a material such as a glass used as the light guide plate 5 and the diffusion sheet 7 is less than or equal to 0.20, in order to reduce generation of brightness unevenness.

According to the embodiment. It is possible to appropriately place a sheet object such as a diffusion sheet at a main surface of a glass.

Although a preferred embodiment of the glass and the glass member has been specifically illustrated and described, it is to be understood that modifications may be made therein without departing from the spirit and scope of the invention as defined by the claims.

The present invention is not limited to the specifically disclosed embodiments, and numerous variations and modifications may be made without departing from the spirit and scope of the present invention.

The present invention can be widely used for a glass on a main surface of which it is necessary to appropriately place a functional sheet object made of a resin material or the like (a diffusion sheet, a shatterproof sheet or a surface protection sheet, for example).

### NUMERALS

1 liquid crystal display
2 liquid crystal panel
3 planar light-emitting device
4 light source
5 light guide plate (glass)
6 reflecting sheet
7 diffusion sheet
8 reflector
10A to 10C reflecting dots
51 light outputting surface (first surface)
52 light reflecting surface (second surface)

What is claimed is:

1. A glass comprising:
a first surface; and
a second surface that is opposite to the first surface,
wherein an absorption coefficient of the glass at light of wavelength 550 nm is less than or equal to 1 m⁻¹, and a ratio (αₘₐₓ /αₘᵢₙ) of a maximum value αₘₐₓ (m⁻¹) to a minimum value αₘᵢₙ (m⁻¹) of absorption coefficients of the glass at light within a range of wavelengths from 400 nm to 700 nm is less than or equal to 10, and
wherein a two-dimensional arithmetical mean height of a selectable area of 1790 μm×1330 μm of the first surface is less than or equal to 1 nm.

2. The glass according to claim 1, wherein a two-dimensional arithmetical mean height of a selectable area of 94 μm×70 μm of the first surface is less than or equal to 0.4 nm.

3. The glass according to claim 1, further comprising 1 to 80 mass ppm of total iron oxide (t-Fe₂O₃) , as calculated in terms of Fe₂O₃.

4. The glass according to claim 1, wherein a surface electrical resistance at the first surface is less than or equal to 2.5×10¹⁴ Ω/□.

5. The glass according to claim 1, wherein a total content of Li₂O, Na₂O and K₂O in the glass is 5 to 20 mass %.

6. The glass according to claim 1,
wherein a minimum value of internal transmittances of the glass at light within a range of wavelengths from 400 to 780 nm, under a condition that an optical length is 200 mm, is greater than or equal to 80%, and
wherein a difference between a maximum value and the minimum value of the internal transmittances is less than or equal to 15%.

7. A glass member comprising:
the glass according to claim 1; and
a functional resin sheet including a resin material as a main component,
wherein the functional resin sheet is provided above the first surface, and
wherein a coefficient of static friction between the functional resin sheet and the glass is less than or equal to 0.20.

8. The glass member according to claim 7, wherein a coefficient of kinetic friction between the functional resin sheet and the glass is less than or equal to 0.20.
